(19) United States
(12) Patent Application Publication
(10) Pub. No.: US 2024/0272716 A1
(43) Pub. Date: Aug. 15, 2024

(54) TELEPATHIC COMMUNICATION DEVICE

(71) Applicant: JAYESHKUMAR RAJENDRABHAI PATEL, AJAX (CA)

(72) Inventor: JAYESHKUMAR RAJENDRABHAI PATEL, AJAX (CA)

(21) Appl. No.: 18/642,439

(22) Filed: Apr. 22, 2024

(51) Int. Cl. G06F 3/01

(52) U.S. Cl. CPC G06F 3/015

(57) ABSTRACT

The present invention relates to a telepathic communication device (100). The telepathic communication device (100) stands for understanding in writing chat or speaking pattern of brain thoughts. The device (100) is for communication without speaking or writing. The device (100) can convert the brain thoughts into writing chat and/or speaking format. This device (100) perform chat that's only understandable informal format instead of exact same spelling of thoughts of words. The sensor (106) sets on the head catches the brain thoughts by analyzing pattern of thinking of the brain. This data transfer to the smart mobile phone/system that has already installed brain waves recognition Telepathy software via wireless connectivity device (107). This software has designed in a such a way that function by converting the electrical signal into the text and/or speech.

### FIELD OF THE INVENTION

The present invention relates to a Telepathic Communication Device which came from original Sanskrit Language word “TELEPATHY’. More particularly, it relates to a telepathic communication device stands for understanding in writing chat or speaking pattern of brain thoughts. The main principle of the present invention is an amplitude measured from head skin vibration (f) while thinking is directly proportional to the respected individual alphabets ( [symbol] ) of the thought words. Hence, Telepathy headsets Sensor measurement readings are dependent on the respective head skin vibration amplitude of alphabets in thought.

### BACKGROUND OF THE INVENTION

Telepathic Communication Device is Reliable Artificial Intelligence with advanced human machine interface that can revolutionize communication than ever before. It can enhance and elevated user interface with ergonomically designed the hardware headsets and the highly distinctive system software. These contribute the fast, convenient, thrilling way of delivering messages, commends, controls towards respective systems with consume less time. Hence, the device will be more energy efficient that inherently supports sustainability.

Recently, people are communicating directly for example by using a smart-phone, computer etc. by speaking or writing the messages. This encompasses at least one sender and the receiver. By, this invention that can add one more feature, that we can communicate without speaking or writing by using this device up to some level.

### PRIOR ART

CN106920548B Patent document discloses a voice control device, a voice control system and a voice control method, wherein the device comprises: the voice acquisition module is used for receiving voice signals; the voice recognition module is used for generating voice characteristics according to the voice signals, judging the voice characteristics according to the current working mode of the voice control device and generating a voice command when judging that the voice characteristics are matched with a voice template corresponding to the current working mode; the first communication module is used for carrying out wireless communication with the intelligent terminal; and the control module is used for generating a control instruction according to the voice command and sending the control instruction to the intelligent terminal through the first wireless communication module so that the intelligent terminal works according to the control instruction. Therefore, the working mode meeting the voice condition of the user can be selected according to the user, the voice recognition accuracy is improved, different requirements of different users on voice control can be met, and voice control such as voice awakening can be performed on the intelligent terminal.

US20180317270A1 Patent document discloses a voice I/O apparatus comprises a voice input unit that acquires uttered voice; a connection control unit that controls connection between the voice I/O apparatus and a control apparatus that generates a response to the voice; and an interaction control unit that transmits the acquired voice to the control apparatus, receives the response to the voice, and outputs the response, wherein the connection control unit establishes, between the voice I/O apparatus and the control apparatus, connection of a voice channel over which the voice is transmitted and connection of a data channel over which data other than the voice is transmitted, and terminates the data channel in a case where the connection of the voice channel is not completed within a given time period from the establishment of the connection of the data channel.

US20230397814 A1 Patent document discloses the embodiments disclose an apparatus including at least one wearable with a plurality of sensors configured to measure physiological signals of the user, an app on a user smart phone wirelessly coupled to the wearable configured for receiving and forwarding wearable measured physiological signals, a digital network cloud platform wirelessly coupled to the app configured for receiving and processing the measured physiological signals, at least one machine learning device coupled to the digital network cloud platform configured for analyzing the measured physiological signals, at least one artificial intelligence device coupled to the at least one machine learning device configured for determining indications of user well-being conditions, at least one computer coupled to the at least one machine learning and artificial intelligence device configured to transmit well-being conditions indications to the digital app on the user smart phone, and transmit the well-being conditions indications to persons selected by the user.

The problem associated with the prior art is, there is a voice input apparatus, and it is controlling the voice only, transmitting AI well-being conditions only & further interaction with the human but it is not AI based device which can detect and understand in writing chat or speaking pattern of brain thoughts. So, the inventors of the present invention came up with the innovation which is telepathic communication device. The prior art fails to understand the brain thoughts, not even AI based tool. The presently telepathic communication device is useful for communication without speaking or writing. This telepathic communication device can convert the brain thoughts into writing chat and speaking (stored speaking signal) format.

### BRIEF SUMMARY OF THE INVENTION

The present invention is all about a telepathic communication device. More particularly, it relates to a telepathic communication device stands for understanding in writing chat or speaking pattern of brain thoughts.

The main aspect of the present invention is to provide a telepathic communication device comprising a Telepathy Headset has a capability to collect the brain waves and transfer those the mobile to convert those waves into speaking or writing format. This has inbuilt system that measure the deviation from ideal (state of without thinking mode) of brain waves to efficiently generate the electrical output. Now, in this turn that output is very useful for the next step.

As per another aspect of the present invention is to provide a telepathic communication device. The Telepathy Software System that is heart of the whole Device. This takes output from Telepathy Headset as input for itself. That compares the stored phonetic values with received electrical input. After that, it will generate new output that is chatting (written) and/or speaking format.

As per another aspect of the present invention is to provide a telepathic communication device. There is a one part of system called Telepathy Headset is required to fit on the head. After carefully putting on the head like any headset, the device requires to turn it on. It's very important to synchronize the Telepathy Headset with the software in the smartphone/system. The brain produces the thoughts. This thought has different words, and these words contain unique frequencies of its associated alphabets & its corresponding sound.

Further, the Telepathy Headset observes the variation in thoughts. This frequency value of thoughts is required to align with the mobile/System Telepathy Software. Before to do so, its paramount to increase the frequency of thought by using frequency Amplification. This is called frequency Enhancement process by using Amplifier inside the Headset. The transducer converts the sensed waves into electrical signal. This is called bidirectional transducer that converts the physical phenomena into electrical signal and vice versa.

Another aspect of the present invention is to provide an electrical signal to the mobile/System recognition Telepathy Software via either Bluetooth or Wi-Fi. This telepathy software has pre-programmed phonetic values of all the available combination of alphabet. The software compares the received output with these values and generate the specific respective thought alphabets. There are obvious limitations on this output that has not exact the same spelling or sound of same person. On the other side, it develops understandable chatting or speaking output.

### BRIEF DESCRIPTION OF THE DRAWINGS

FIG. 1 elaborated a schematic diagram of the telepathic commination device. The internal connection and component arrangement shown in the FIG. 1.

FIG. 2 represent the block diagram of the telepathic communication device.

### DETAILED DESCRIPTION OF THE INVENTION

The above and other objects and features of the present invention will become apparent from the following description of the invention, when taken in conjunction with the accompanying drawings, in which: Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Unless defined otherwise, all technical and scientific terms used herein have the same meaning as commonly understood by one of ordinary skill in the art to which the invention belongs.

As per main embodiment of the present invention is to provide a telepathic communication device (100) comprising:
a Telepathy headset has a capability to collect the brain waves through inbuilt sensors and transfer those to the mobile to convert those waves data into speaking or writing format.
an inbuilt system that measures the deviation from ideal (state of without thinking mode) of brain waves to efficiently generate the electrical output; that output is very useful for the next step.

As per another embodiment of the present invention is to provide a telepathic communication device (100) having Telepathy Software. This takes output from Telepathy Headset as input for itself. That compares the stored phonetic values with received electrical input. After that, it will generate new output that is chatting (written) and/or speaking format.

As per another embodiment of the present invention is to provide a telepathic communication device (100) having a Sensor transducer (101) being capable to converts some sort of energy to sound (source) or converts sound energy (receiver) to an electrical signal. The telepathic communication device (100) provides a headset frame device (109) major part that includes major components in their conduit housing and on peripherals.

As per one embodiment of the present invention is to provide a head skin Microsensor (106) of the device from headset can sense the micro vibrations amplitude from side of the head skin nerve while thinking and transmit output via circuit board to the recipient individual systems.

As per one embodiment of the present invention is to provide an integrated circuit (IC) board (103). The said circuit board (103) is directly connected with sensor (106) output, processes the signal received from sensor (106) with capability to amplify the signal, to transfer via wireless connectivity device (107) that is Bluetooth and Wi-Fi, Transducer (101) for wireless signal transmission.

As per one embodiment of the present invention is to provide a sensor (106) signal Amplification being capable of measured brain thought signals from sensor are very small to be process for the AI based data measurement, thus it is required to amplify up to optimum level that provide seamless operation for Micro Controller Hardware and Software embedding that can take place. The components are mounted on the IC board and will perform as the signal transmitter that will convert the amplified signal into radio signals and wirelessly send this output with the systems with the help of processor chip (104). For ex. write word on Display/within an App (102), Speaking output from receiver, Automatic operation etc.

As per one embodiment of the present invention is to provide a processor chip (104) for data processing which is reliable AI based with help of machine learning algorithm that will be installed on this chip (104). This means, the accurate data will be generated as per thought and give output with connected systems.

As per one embodiment of the present invention is to provide a telepathic communication device (100) having display screen (102) having the glass to display output of the telepathic communication device (100). This showcases the basic function of the telepathic communication device (100). The output system changes as per the application including but not limited to Mobile, Computer, Robotics, Gaming, Speaking Accessibility and more.

As per one embodiment of the present invention is to provide a speaker (108) being capable to generate the verbal output, we use the text to speech methodology will connect with this Speaker (108). This speaker (108) having magnetic voice coil type to convert the sounds waves into audio signals operated with the help of D.C. battery (110). The D.C. battery (110) gives power to the above components to perform their predefined functions. This D.C battery (110) ranges around 5V, 1.6 A.

The present invention overcomes the problem of a Telepathic Communication Device (100). The telepathic communication device (100) stands for understanding in writing chat or speaking pattern of brain thoughts. The object, features, and advantages of the present invention will now be described in greater detail. Also, the following description includes various specific details and is to be regarded as merely exemplary. Accordingly, those of ordinary skill in the art will recognize that: without departing from the scope and spirit of the present disclosure and its various embodiments there may be any number of changes and modifications described herein.

It must also be noted that as used herein and in the appended claims, the singular forms “a”, “an,” and “the” include plural references unless the context clearly dictates otherwise. Although any systems and methods similar or equivalent to those described herein can be used in the practice or testing of embodiments of the present invention, the preferred, systems are now described.

### OBJECT OF THE INVENTION

The principal object of the present invention is to provide a telepathic communication device.

Another object of the present invention is to provide a telepathic communication device being capable to understanding in writing chat or speaking pattern of brain thoughts.

Yet another object of the present invention is to provide a telepathic communication device being capable to convert the brain thoughts into writing chat (Not exactly same spelling format) and/or speaking (stored speaking signal) format.

One more object of the present invention is to provide a telepathic communication device being capable to specified writing chats between sender and receiver aren't same spelling as being thought because this device will perform chat that's only understandable informal format instead of exact same spelling of thoughts of words.

Another object of the present invention is to provide a telepathic communication device having sensor sets on the head catches the brain thoughts by analyzing pattern of thinking of the brain. This data will then transfer to the smart Mobile phone that has already installed brain waves recognition Telepathy Software via Bluetooth or Wi-Fi. This software has designed in a such a way that function by converting the electrical signal into the text and/or speech.

Another object of the present invention is to provide a telepathic communication device, the Telepathy Headset has a capability to collect the brain waves and transfer those the mobile to convert those waves into speaking or writing format. The thought contain in the brain waves are detected from the Head Skin micro vibrations using the sensor. This Sensor has inbuilt system that measure the deviation from ideal (state of without thinking mode) of brain waves to efficiently generate the electrical output.

Another object of the present invention is to provide a telepathic communication device, the Telepathy software. This takes output from Telepathy Headsets as input for itself. That compares the stored phonetic values with received electrical input and it will generate new output that is chatting (written) and/or speaking format.

Another object of the present invention is to provide a telepathic communication device, which is Economical, Accurate, Reliable & User-Friendly device.

### OPERATION OF THE PRESENT INVENTION

The brain produces the thoughts to communicate. This thought contains different words, and these words has physical property called the frequency which is unique for each alphabet of the words. To analyze these words of thought, it is essential to capture the frequency/amplitude (105) of it. To accomplish this task, there is a one part of the system called Telepathy Headset can be designed with various shapes and Sizes, that is required to wear like normal headsets. It consists of electronic circuit connected with sensor which powered by DC current battery (110).

After, carefully putting the headset on the head, so that, the sensors (106) of the headset can detect head-skin nerve micro vibrations and it requires to turn it on. It is very important to synchronize the headset with the software of the respective systems where this device is using. The telepathic communication device (100) must work with this distinctive system Software and the output of the Telepathy Headset is processed by this Telepathy Software. Here, there is an ideal state of the headset refers to the specific time when the user is not actively thinking and sensors (106) can't receive any data and the deviation means the user is now in thinking mode and has some thought in mind, those can be sensed by the sensors (106).

Further, this deviation has the frequency values of each alphabet contained in thought that can be detected by the sensors (106) on the head-skin. These values of frequencies of each alphabet are required to be compared with the stored preprogrammed phonetic values of the frequencies of all the available combination of alphabets within the software. This software is computer language code written to perform the data analysis received from brain Telepathy Headset's sensor (106) to develop the more reliable Artificial Intelligence system. Before to do so, it is paramount to increase the frequency of thought by using the Frequency Amplification (105) to align with the stored data in the software.

Further, this frequency enhancement process is done by using the Amplifier inside the Telepathy Headset. The transducer (101) of the device can convert the sensor data into the electrical signal. This bi-directional transducer (101) that converts the physical phenomena i.e., the frequency values into the electrical signal and vice versa.

The next step is, to send this electrical signal to the system software via either wireless connectivity device (107) that is Bluetooth and/or Wi-Fi. The software will compare the Sensor Data with these stored values and generate or display (102) the specific respective words of the alphabets, spoken output (through speaker 108) or commends depending on the system.

Furthermore, the device consists of frame (109) and the digital Screen (102). The frame (109) is carrying the sensor (106) with embedded electronic circuit for sensing micro measurements from head skin vibration while thinking which transmitted via Bluetooth transmitter and output is display on a digital screen (102). There are obvious limitations on this output that has not the exact same spelling or sound of same person. On the other side, it can develop the understandable chatting, speaking output or commends in the system.

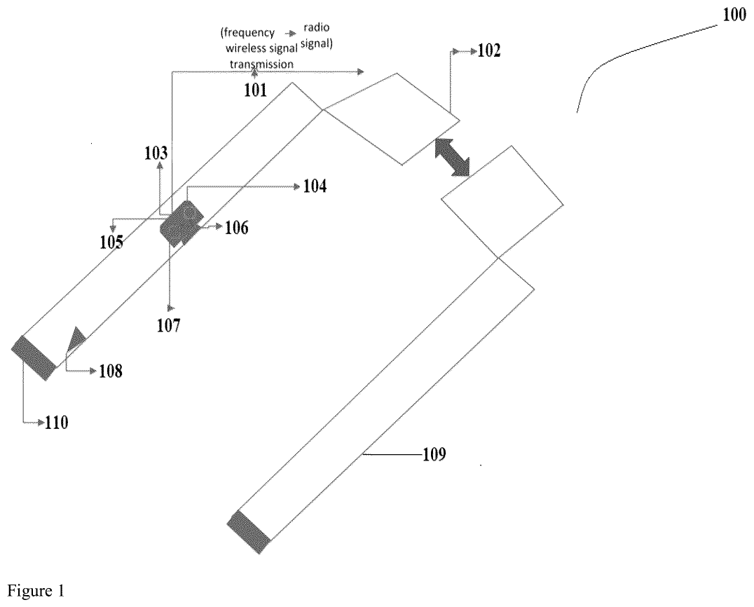

Referring FIG. 1 represent the arrangement of the components of the telepathic communication device (100). The FIG. 1 having all components and connection in the telepathic communication device (100) stands for understanding of brain thoughts in writing chats or spoken words. This means to convert the thoughts by means of this device (100) into writing or speaking format. The sensor (106) of the device sets on the side part of human head can sense the brain thoughts patterns and can convert into writing chat (Not the same spelling format) and/or speaking (based on stored speech values) format. Here, specified that the writing chats between sender and receiver aren't the same spelling as being thought, because this device (100) perform the chat that's only understandable informal format instead of exact same spelling of thoughts of words. The same situation happens with the speaking too because the output sound isn't belonging to the same person at early stage.

Continuously referring FIG. 1 of the present invention, it is just speaking the words respect to person's thought's frequency values. The sensor (106) senses the data from head skin nerve that senses the brain's thoughts and analyzing each frequency of alphabets. This data will then transfer to the system (i.e., Phone, Computer, etc.) that has already installed the software via Bluetooth and Wi-Fi. This software has designed in a such a way that function by converting that radio signals into the text and/or speech.

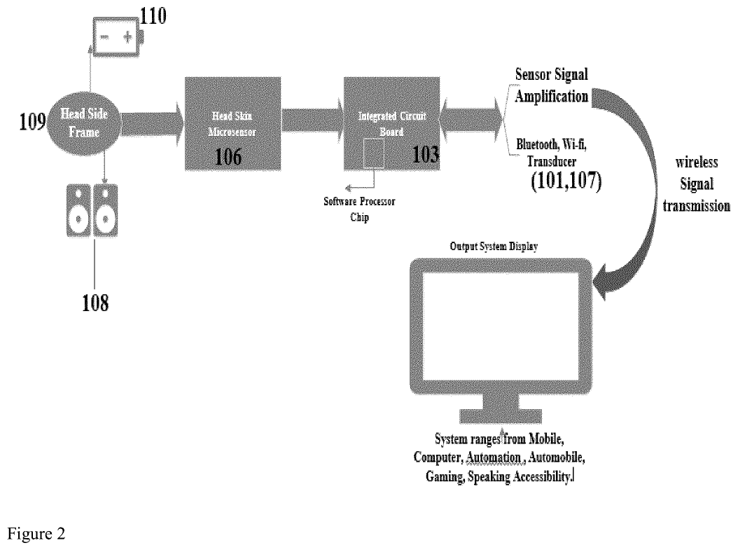

Referring FIG. 2 represent the block diagram of the telepathic communication device (100). The headset frame (109) device major part that includes major components in their conduit housing and on peripherals. The head skin microsensor (106) of the device from headset can sense the micro vibrations amplitude from side of the head while thinking and transmit output via circuit board (103) to the recipient individual systems. The integrated Circuit (IC) board (103). The said circuit board is directly connected with sensor (106) output, processes the signal received from Sensor (106) with capability to amplify the signal, to transfer via wireless connectivity device (107) that is Bluetooth and Wi-Fi, Transducer (101) for wireless signal transmission. The sensor (106) signal amplification being capable to brain thought signals measured from sensor (106) are very small to be process for data measurement for AI based, thus it is required to amplify up to optimum level that provide seamless operation for Hardware and software embedding can take place.

Continuously referring FIG. 2 of the present invention, the components are mounted on the IC board and will perform as the signal transmitter that converts the amplified signal into radio signals and wirelessly send this output with the systems with the help of processor chip (104). The data will then transfer to the system (i.e., Phone, Computer, etc.) that has already installed the software via Bluetooth and Wi-Fi. This software has designed in a such a way that function by converting that radio signals into the text and/or speech.

### ADVANTAGEOUS EFFECT OF THE PRESENT INVENTION

The present invention, telepathic communication device (100) having advantages which are given below:

It will enhance and elevate user interface with ergonomically designed the Telepathy hardware headsets and the highly distinctive Telepathy Software System.

These contribute to the fast, convenient, thrilling way of delivering messages, commends, controls towards respective systems with consume less time. Hence, the device (100) is boosting productivity & more energy efficient that inherently supports sustainability.

The telepathic communication device (100) can interpret with the brain thoughts and use this to perform the tasks directly with using the device (100) from human brain thoughts.

This enhances the ergonomics, Human machine relationship with AI and communication technology. This device (100) can operate the current systems including the Mobile, Computer, Machine, Automobile, and more similar technological Platform with only thinking with the use of Telepathic Communication Device.

Without further description, it is believed that one of ordinary skill in the art can, using the preceding description and the illustrative examples, make and utilize the present invention and practice the claimed methods. The foregoing discussion and examples merely present a detailed description of certain preferred embodiments. It will be apparent to those of ordinary skill in the art that various modifications and equivalents can be made without departing from the spirit and scope of the invention.

### LIST OF THE REFERENCE NUMERALS

100 Telepathic communication devices
101 Transducer
102 Display output screens.
103 Integrated circuit board
104 Chip
105 Frequency amplifier
106 Head skin Sensors
107 Wireless connectivity devices
108 Speaker
109 Head side frame
110 D.C battery

I/We claim:

1. Telepathy Headset of the Telepathic Communication Device (100) has a capability to interpret the brain waves through the detecting Head Skin micro vibrations from the Sensor and transmit these measured Sensor data to the mobile/end User Systems to convert these data into speaking and/or writing format in which sensor has inbuilt system that measure the deviation from ideal state of without thinking mode of brain waves to efficiently generate the Sensor electrical output.

2. Telepathy Software System is the combination of the Artificial Intelligence (AI) & its associated output System are being capable of comparing the input Sensor Data with its stored phonetic values of the alphabets, Data related to actions (Commends, Controls etc.) and will generate the respective new output that is Chatting (Written), Speaking format, and/or corresponding Actions.
